(19) United States
(12) Patent Application Publication
(10) Pub. No.: US 2022/0169297 A1
(43) Pub. Date: Jun. 2, 2022

(54) SYSTEMS, METHODS, AND APPARATUS FOR PROVIDING A COMPACT AUTOMATIC FOLDING STROLLER

(71) Applicant: GRACO CHILDREN'S PRODUCTS, INC., Atlanta, GA (US)

(72) Inventors: Jordi Dorca PUJOL, Sant Joan de les Abadesses (ES); Lin LI, Qingxi Town, Dongguan (CN); Xiao Qun ZHAO, Qingxi Town, Dongguan (CN)

(73) Assignee: GRACO CHILDREN'S PRODUCTS, INC., Atlanta, GA (US)

(21) Appl. No.: 17/538,991

(22) Filed: Nov. 30, 2021

Related U.S. Application Data
(60) Provisional application No. 63/119,506, filed on Nov. 30, 2020.

(51) Int. Cl. B62B 7/08; B62B 9/20

(52) U.S. Cl. CPC B62B 7/086; B62B 2205/20; B62B 9/20

(57) ABSTRACT

Embodiments disclosed herein are generally related to children's stroller systems and more particularly to systems, methods, and apparatus for providing a compact automatic folding stroller. In at least one embodiment, a compact automatic folding stroller can be provided. The stroller can include a stroller frame comprising a handle member, a front leg member, and a rear leg member; and a hub mechanism, wherein the handle member, front leg member, and rear leg member are coupled to one another via the hub mechanism, the hub mechanism includes: a handle arm operable to connect to a lower portion of the handle member; a front leg arm operable to connect to the front leg member; and a rear leg arm operable to connect to the rear leg member; and a linkage operable to coordinate movements of the handle arm, front leg arm, and rear leg arm; wherein when an upper portion of the handle member is manipulated towards the lower portion of the handle member, the hub mechanism releases the linkage, causing the linkage to: rotate the front leg arm to fold the front leg member towards the rear leg member; rotate the handle arm to fold the lower portion of the handle member towards the rear leg member; wherein the front leg member, upper portion of the handle member, and lower portion of the handle member can be maintained in a folded configuration with respect to the rear leg member.

### RELATED APPLICATION

The present application claims priority to U.S. Ser. No. 63/119,506, filed Nov. 30, 2020, the contents of which are incorporated by reference.

### TECHNICAL FIELD

Embodiments disclosed herein are generally related to children's stroller systems and more particularly to systems, methods, and apparatus for providing a compact automatic folding stroller.

### BACKGROUND

Many conventional strollers can be awkward to fold or collapse, particularly when a stroller requires two hands of a user to initiate and fold or collapse the stroller, and the user may only have a single hand free. In some instances, conventional strollers may have an outer crossbar and mechanism that coordinates linking various components of the stroller together to facilitate folding or collapse of the stroller. However, such strollers can pose a finger entrapment risk and may have less aesthetic appeal to consumers.

### BRIEF DESCRIPTION OF THE SEVERAL VIEWS OF THE DRAWINGS

For a more complete understanding of the present disclosure and certain features thereof, reference is now made to the following description, in conjunction with the accompanying figures briefly described as follows:

FIG. 1 illustrates a perspective view of an example compact automatic folding stroller in an open or use configuration, according to an embodiment of the disclosure.

FIG. 2 illustrates a perspective view of an example stroller frame for the compact automatic folding stroller shown in FIG. 1, according to an embodiment of the disclosure.

FIG. 3 illustrates a perspective view of an example handle member for the stroller frame shown in FIG. 2, according to an example embodiment of the disclosure.

FIG. 4 illustrates a perspective cutaway view of the example handle member shown in FIG. 3, according to an example embodiment of the disclosure.

FIG. 5 is a side cutaway view of the example handle member shown in FIG. 3 and example hub mechanism, according to an example embodiment of the disclosure.

FIG. 6 is a side cutaway partial disassembled view of an example linkage for the hub mechanism shown in FIG. 5, according to an example embodiment of the disclosure.

FIG. 7 is a side cutaway view of an example hub mechanism shown in FIGS. 5 and 6, according to an example embodiment of the disclosure.

FIG. 8 is an exploded perspective view of the example hub mechanism shown in FIGS. 5-7, according to an example embodiment of the disclosure.

FIG. 9 is a perspective cutaway view of an example rear leg member for the stroller of FIG. 1 and hub mechanism shown in FIGS. 5-8, according to an example embodiment of the disclosure.

FIG. 10 is a side cutaway view of an example rear leg member shown in FIG. 9 and hub mechanism shown in FIGS. 5-9, according to an embodiment of the disclosure.

FIGS. 11A-11F present multiple views of the example stroller frame shown in FIG. 2 configured to fold from a use configuration to a folded configuration using the hub mechanism shown in FIGS. 5-10, according to an example embodiment of the disclosure.

FIGS. 12A-12C illustrate an example backrest configuration for the example stroller of FIG. 1 and stroller frame of FIG. 2, according to an example embodiment of the disclosure.

Example embodiments now will be described more fully hereinafter with reference to the accompanying drawings, in which example embodiments are shown. The concept disclosed herein may, however, be embodied in many different forms and should not be construed as limited to the exemplary embodiments set forth herein; rather, these embodiments are provided so that this disclosure will be thorough and complete, and will fully convey the scope of the claimed concept to those of ordinary skill in the art. Like numbers refer to like, but not necessarily the same, elements throughout.

### DETAILED DESCRIPTION OF THE EXAMPLE EMBODIMENTS

The example embodiments described herein and shown in the figures are described with reference to an infant or child's stroller (referred to hereinafter as a “child's stroller”) that includes a hub mechanism that couples together a handle member, front leg member, and rear leg member, wherein the hub mechanism facilitates manipulating the child's stroller from a use configuration to a folded configuration. The child's stroller further includes a linkage operable to coordinate movements of the handle member, front leg member, and rear leg member, wherein when an upper portion of the handle member is manipulated towards the lower portion of the handle member, the hub mechanism releases the linkage, causing the linkage to fold the front leg member towards the rear leg member; rotate the handle member towards the rear leg member, wherein the front leg member, upper portion of the handle member, and lower portion of the handle member can be maintained in a folded configuration with respect to the rear leg member. As described herein, embodiments of the disclosure can provide technical solutions to the closing and folding of a relatively compact stroller frame from an open and unfolded configuration.

Certain dimensions and features of the example child's stroller are described herein using the term “approximately.” As used herein, the term “approximately” indicates that each of the described dimensions is not a strict boundary or parameter and does not exclude functionally similar variations therefrom. Unless context or the description indicates otherwise, the use of the term “approximately” in connection with a numerical parameter indicates that the numerical parameter includes variations that, using mathematical and industrial principles accepted in the art (e.g., rounding, measurement or other systematic errors, manufacturing tolerances, etc.), would not vary the least significant digit.

In addition, certain relationships between dimensions of the stroller and between features of the stroller are described herein using the term “substantially.” As used herein, the terms “substantially” and “substantially equal” indicates that the equal relationship is not a strict relationship and does not exclude functionally similar variations therefrom. Unless context or the description indicates otherwise, the use of the term “substantially” or “substantially equal” in connection with two or more described dimensions indicates that the equal relationship between the dimensions includes variations that, using mathematical and industrial principles accepted in the art (e.g., rounding, measurement or other systematic errors, manufacturing tolerances, etc.), would not vary the least significant digit of the dimensions. As used herein, the term “substantially constant” indicates that the constant relationship is not a strict relationship and does not exclude functionally similar variations therefrom. As used herein, the term “substantially parallel” indicates that the parallel relationship is not a strict relationship and does not exclude functionally similar variations therefrom.

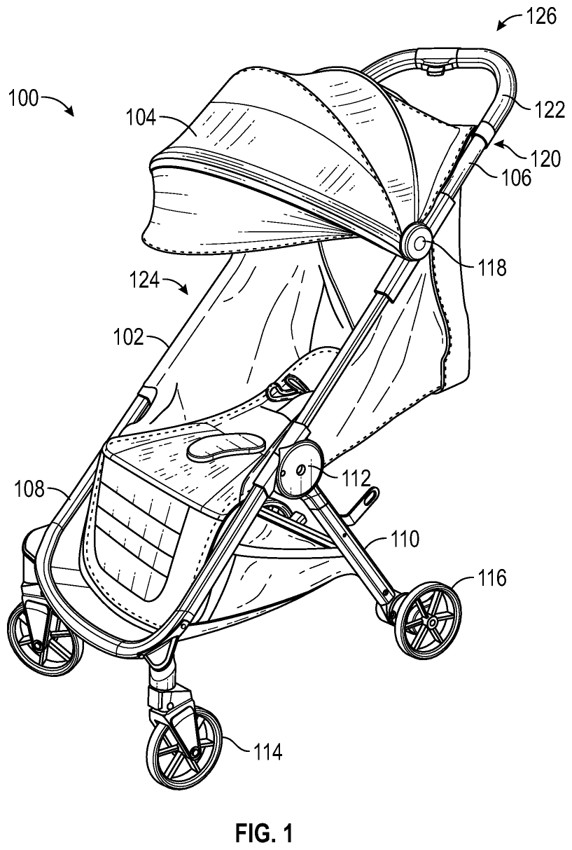

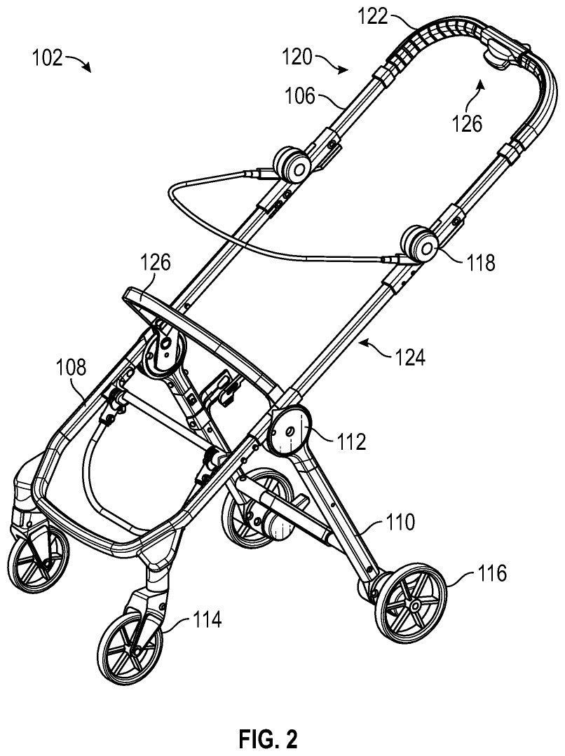

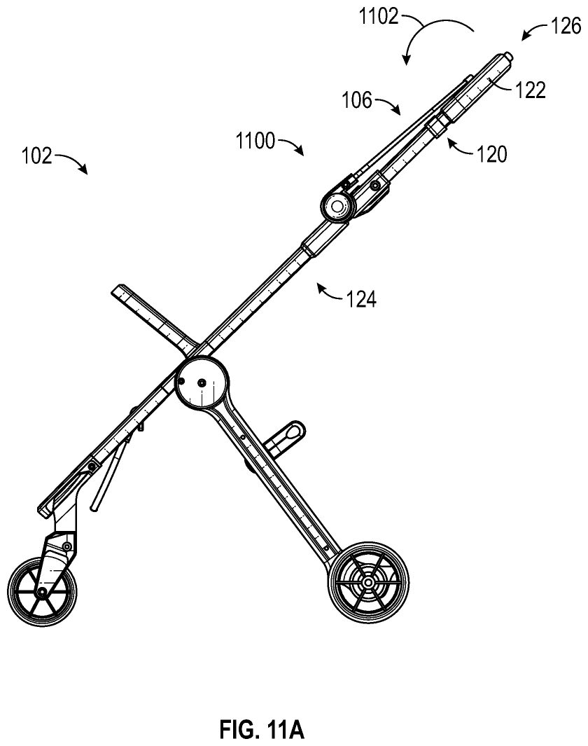

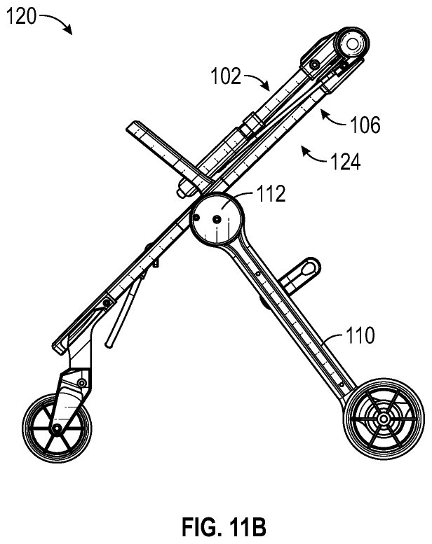

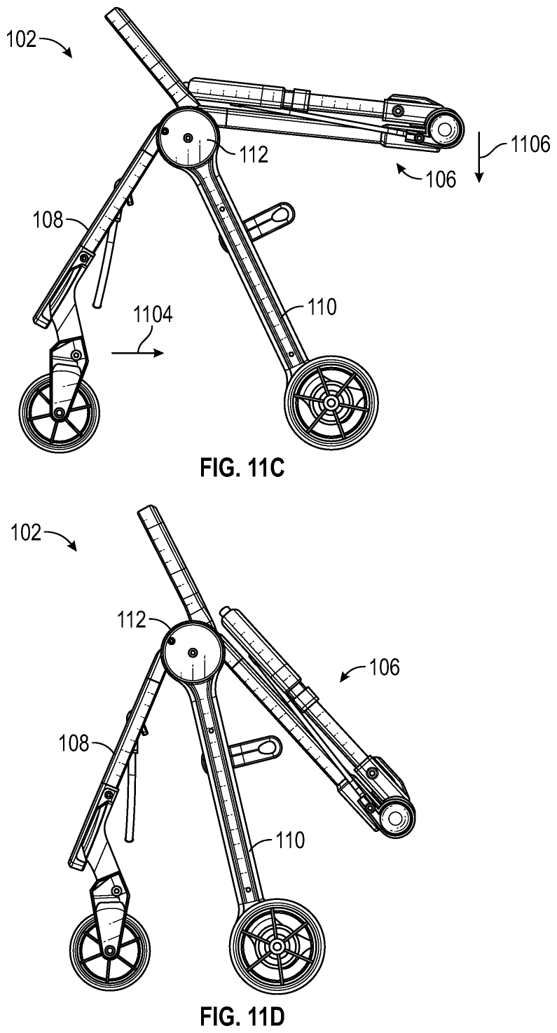

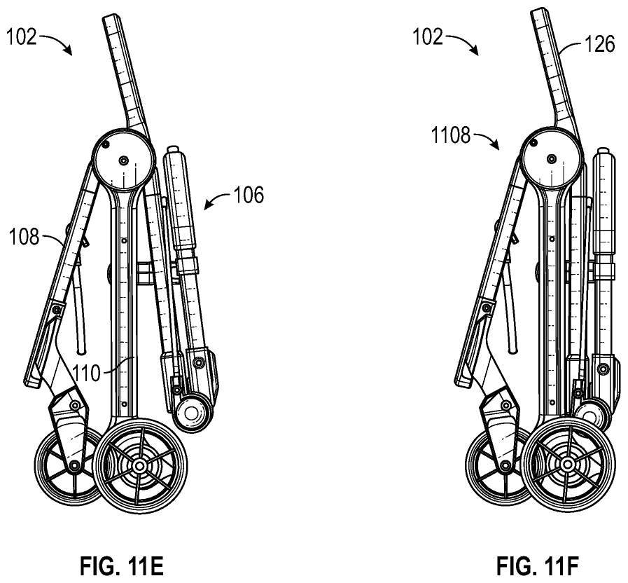

FIG. 1 illustrates a side view of an example stroller frame for a compact automatic folding stroller in a fully opened or use configuration, according to an embodiment of the disclosure. FIG. 2 illustrates a perspective view of an example stroller frame for a compact automatic folding stroller shown in FIG. 1, without any soft goods or seats, according to an embodiment of the disclosure. Referring now to FIG. 1, the example compact automatic folding stroller 100 can include a stroller frame 102 capable of supporting one or more stroller seats and/or soft goods 104 for providing a stroller seat. When in use, a user can, with a single hand, initiate automatic folding of the stroller 100, wherein the stroller 100 can automatically fold from the example open or use configuration shown in FIG. 11A into an example relatively compact, closed or folded configuration as shown in FIG. 11F. In some embodiments, the total linear measurement of an example compact automatic folding stroller in a closed or folded configuration can meet the U.S. domestic and/or international airline linear measurement requirements for carry-on and/or overhead baggage. When the user desires to close or fold the stroller 100, the user can initiate the closing or folding operation by manually releasing one or more components of the stroller 100 which cause various other components to automatically close and fold the stroller 100 into a relatively compact, closed or folded configuration. Conversely, when the user desires to open the stroller 100 from the closed or folded configuration, the user can initiate the opening operation by manually releasing one or more components of the stroller 100 which cause various other components to open and unfold the stroller 100 from the relatively compact, closed or folded configuration, to the use or open configuration.

In one example embodiment, the stroller frame can include one or more handle members 106, one or more front leg members 108 (only a single front leg member is shown in certain side views, such as in FIGS. 11A-11F, but can be two or more separate and spaced apart front leg members), one or more rear leg members 110 (only a single rear leg member is shown in certain side views, such as in FIGS. 11A-11F, but can be two or more separate and spaced apart rear leg members), a hub mechanism 112, one or more front wheels 114, and one or more rear wheels 116. In one example embodiment, the stroller frame can made of one or more pieces fixedly coupled and/or movably coupled to one another. The stroller frame 102 can include portions that are hollow tubing and other portions that are solid core tubing and can be made from metal, plastic, composites, or other materials known in the art.

Other soft goods configurations than those shown in FIG. 1 can be used with a stroller 100, and one skilled in the art will recognize how to implement these other soft goods configurations with various embodiments according to the disclosure.

In certain embodiments, the stroller 100 can also include a stroller seat either fixedly or removably coupled to the stroller frame 102. The stroller seat may be implemented or otherwise complemented with a relatively rigid seat structure and/or soft goods, such as padding and/or cotton, nylon, polyester or other types of fabric. In certain embodiments, the stroller 100 can also include one or more shoulder restraint belts configured to go over a child's corresponding right and left shoulders and down their torso to hold the child securely in the stroller seat. In certain embodiments, the stroller 100 can include a left waist harness and a right waist harness, each configured to be positioned between the child's legs when the child is in the stroller seat, the left waist harness can be positioned along the left side of the child in the waist area and the right waist harness can be positioned along the right side of the child in the waist area. In one example, a coupling device or seat belt can be removably coupled to the right shoulder belt restraint, the left shoulder belt restraint, the left waist harness, and the right waist harness.

The example stroller 100 shown in FIG. 1 can include one or more handle members 106. The one or more handle members 106 can be relatively elongated shaped members configured to permit a user to push the stroller 100 or otherwise transfer a user's force applied to the one or more handle members 106 to one or more wheels 114, 116 associated with the stroller 100 to move the stroller 100 forward along a surface, such as the ground. In the use configuration of the example stroller 100, each handle member 106 can extend upward from a hub mechanism 112, which also connects to a respective rear leg member 110 and front leg member 108. Each handle member 106 can be configured to fold at a respective pivot device 118 positioned in approximately a central portion of the respective handle member 106 itself, wherein an upper portion 120 of the handle frame member 102 can fold at the pivot device 118. From the use configuration of the stroller 100, each handle member 102 can fold at the respective pivot device 118, wherein a distal end 122 of the upper portion 118 of the handle member 106 can fold towards a lower portion 124 of the handle member 106. From the folded configuration of the stroller 100, each handle frame member 106 can fold at the respective pivot device 118, wherein the distal end 122 of the upper portion 120 of the handle member 106 can extend away from the lower portion 124 of the handle member 106, such that the handle member 106 is in an extended position.

In the embodiment shown, an example crossbar 126 can extend between two opposing handle members 106 near or at the hub mechanism 112. The crossbar shown can be a curved member operable to permit handling or carrying of the stroller 100 and frame 102 when in a closed or folded configuration, as shown in FIG. 11F, described below.

The example stroller 100 shown in FIG. 1 can include one or more front leg members 108. The one or more front leg members 108 can be relatively elongated straight and/or slightly curved shaped members configured to receive from other components of the stroller 100 a user's force applied to the one or more handle members 106, and further configured transfer the user's force to one or more wheels 114 mounted to the one or more front leg members 108 to move the stroller 100 forward along a surface, such as the ground. Each front leg member 108 can include a respective front wheel 114 at a lower distal end of a lower portion of the respective front leg member 108. A corresponding front wheel assembly can mount the front wheel 114 to the lower distal end of the lower portion of the respective front leg member 108. At an upper portion of the front leg member 108, each front leg member 108 can connect to a respective hub mechanism 112, which is configured to permit the corresponding front leg member 108 to pivot or otherwise rotate towards and/or away from one or more rear leg members 110. When the stroller 100 is in the use configuration as shown in FIGS. 1, 2, and 11A, each front leg member 108 can pivot at the respective hub mechanism 112, wherein the lower distal end of the front leg member 108 can fold towards one or more rear leg members 110. When the stroller 100 is in the folded configuration as shown in FIG. 11F, each front leg member 108 can pivot at the respective hub mechanism 112, wherein the lower distal end of the front leg member 108 can extend away from the respective rear leg member 110.

The example stroller 100 shown in FIG. 1 can include one or more rear leg members 110. The one or more rear leg members 110 can be relatively elongated straight and/or curved shaped members configured to receive from other components of the stroller 100 a user's force applied to the one or more handle members 106, and further configured transfer the user's force to one or more wheels mounted to the one or more rear leg members 110 to move the stroller 100 forward along a surface, such as the ground. Each rear leg member 110 can include a rear wheel 116 at a distal end of a lower portion of the respective rear leg member 110. A corresponding rear wheel assembly can mount the rear wheel 116 to the distal end of the lower portion of the respective rear leg member 110. At an upper portion of the rear leg member 110, a respective hub mechanism 112 can connect to the respective rear leg member 110, thereby coordinating movement between the respective front leg member 108, handle member 106, and rear leg member 110.

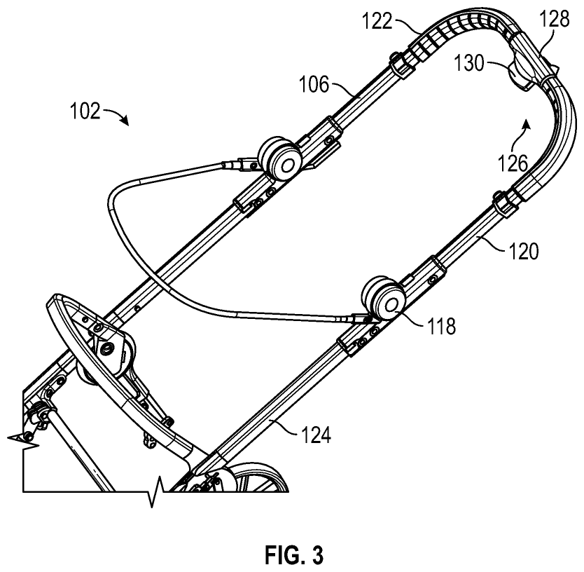

As shown in FIGS. 1-4, one or more of the handle members 106 can include a respective release mechanism 126 configured to initiate folding of a distal end portion 122 of the upper portion 120 of the respective handle member 116 towards the lower portion 124 of the handle member 106, or generally in the direction of a respective front leg member 108, wherein an initial length of the handle member 106 is shortened to a folded length of the handle member 106. In certain embodiments, a release mechanism can be a combination of an initial release thumb button or switch, such as 128 in FIG. 3, and a secondary release of a pull switch or squeeze button, such as 130 in FIG. 3, wherein the initial release and secondary release can be manipulated by a single hand of a user. In certain embodiments, one or more first releases can be positioned near the distal end portion 122 of the upper portion 120 of the handle member 106, or may otherwise be positioned along the handle member 106 on one or more lateral sides of and/or lower portion 124 of the handle member 106.

In any instance, a release mechanism can include, but is not limited to, at least one of a button, a tether, a wire, a cable, a string, a rope, a strap, a slide switch, or a latch. Other release mechanisms and corresponding operations can be used with a stroller 100, and one skilled in the art will recognize how to implement these other release mechanisms and corresponding operations with various embodiments according to the disclosure.

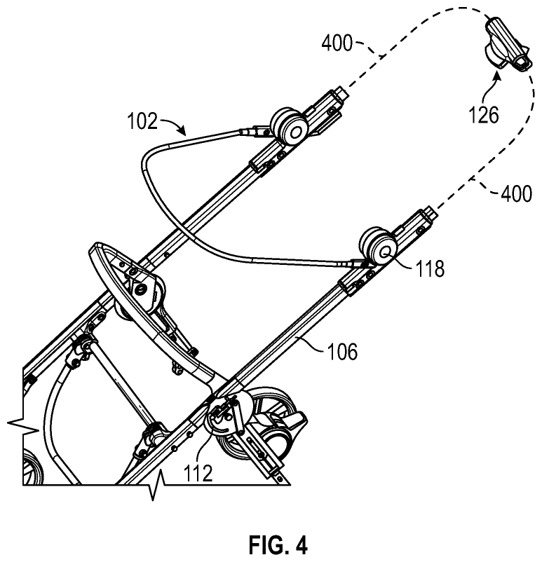

As shown in the partial cutaway view of FIG. 4, the release mechanism 126 can be connected to one or more cables 400, which, shown as dotted lines, can be routed inside one or more handle members 106 from the distal end portion 122 to the pivot device 118, and further to the hub mechanism 122. When the release mechanism 126, for example, the initial release and secondary release, is actuated, the distal end portion 122 of the upper portion 120 of the handle member 106 can be released and can begin folding at the pivot device 118 towards a lower portion 124 of the handle member 106.

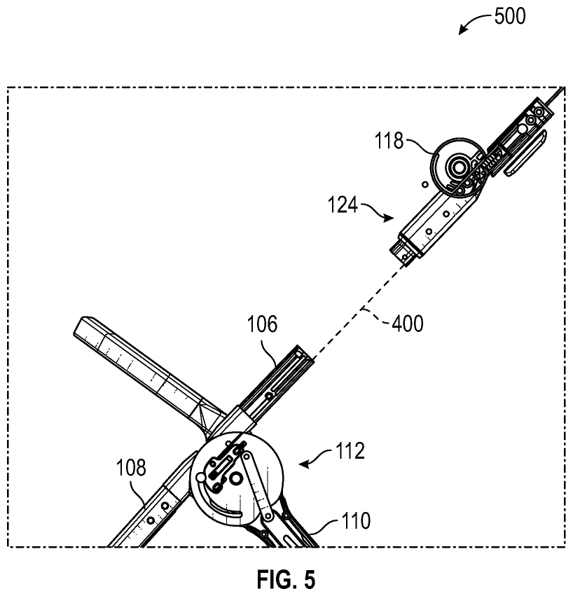

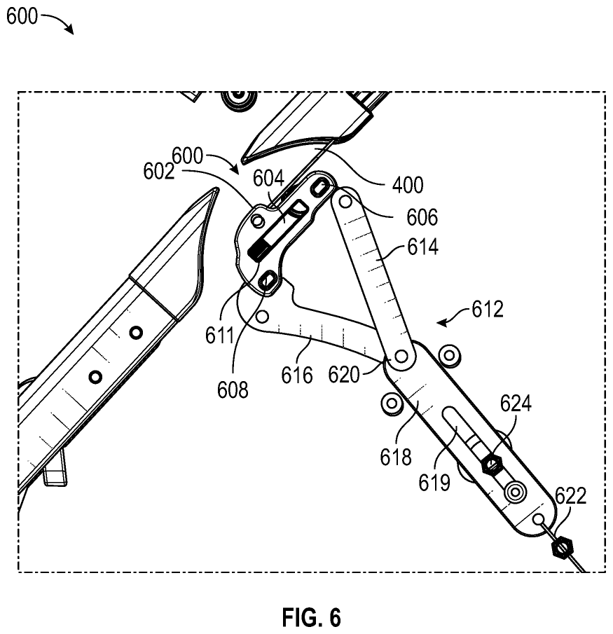

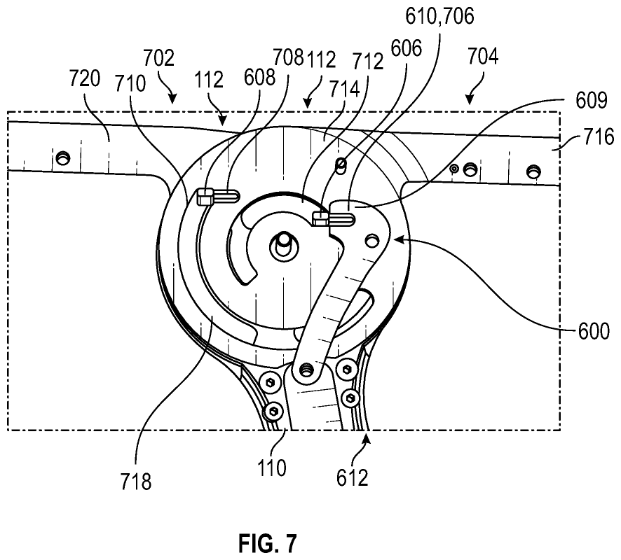

As depicted in FIG. 5, as the upper portion 120 of the handle member 106 rotates in the direction shown by, for example, arrow 500, to fold the upper portion 120 of the handle member 106 towards the lower portion 124 of the handle member 106, the one or more cables 400 can begin tensioning in the lower portion 124 of the handle member 106, thus releasing a lock in the hub mechanism 112. As shown in the cutaway views of the hub mechanism 112 of FIGS. 6 and 7, an example lock 600 can include a slotted arm 602 with a slot 604, a pair of knobs 606, 608 each adjacent to opposing ends of the slotted arm 602, a lock arm 609 with a lock slot 610 at one end of the lock arm 609, and a lock pivot member 611, which can coordinate with the one or more handle members 106 to minimize play and wobble in the one or more handle members 106. The slotted arm 602 within the hub mechanism 112 can be manipulated with respect to the lock pivot member 611 with the one or more cables 400, to initiate movement of the lock 600 from a locked position when the stroller 100 is in a fully open or use configuration, as shown in FIGS. 1 and 11A, to an unlocked position when the stroller 100 is manipulated towards a closed or folded configuration, as shown in FIG. 11F.

As shown in FIG. 7, the pair of knobs 606, 608 can coordinate with various components of the hub mechanism 112, such as, for example, the lock arm 609, linkage 612, front leg hub plate 702, central hub plate 703, and handle hub plate 704. With the manipulation of the lock 600 in the hub mechanism 112 by a force on the one or more cables 400, the lock 600 and pair of knobs 606, 608 can move with respect to the lock slot 610 and lock arm 609 as well as the corresponding slots 706, 708 in both the front leg hub plate 702 and central hub plate 703. As shown in FIGS. 6 and 7, the knob 606 can be moved from the lock slot 610 of the lock arm 609, and the pair of knobs 606, 608 can be moved from the respective slots 706, 708 to permit respective rotation of the front leg hub plate 702 and handle hub plate 704 with respect to the central hub plate 703, wherein the knobs 606, 608 can move within respective curved slots 710, 712 in both the front leg hub plate 702 and central hub plate 703, and further coordinate movement of the linkage 612 as explained in further detail below. Thus, when the front leg hub plate 702 is permitted to rotate, the one or more front leg members 108 can rotate towards the one or more rear leg members 110. Likewise, when the handle hub plate 704 is permitted to rotate, the one or more handle members 106 can also rotate towards the one or more rear leg members 110.

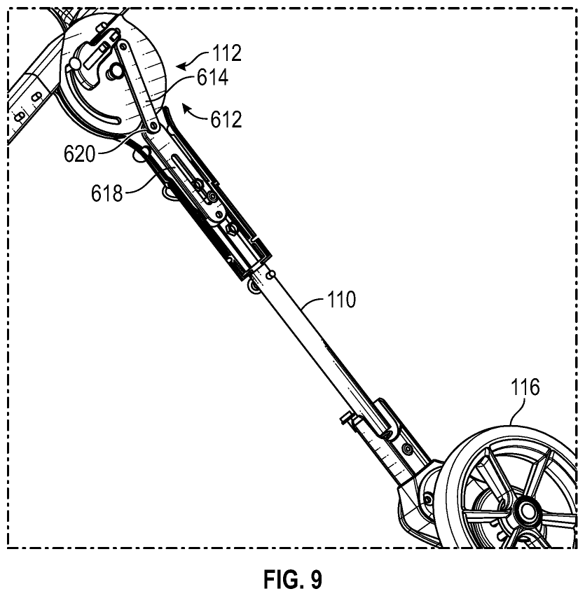

As further shown in FIGS. 6, 7, 8, 9, and 10, the hub mechanism 112 can include a linkage 612 configured to coordinate movement of the one or more front leg members 108, handle members 106, and rear leg members 110. The linkage 612 can extend from the hub mechanism 112 to one or more rear leg members 110. In this embodiment, the slider mechanism or linkage 612 can extend inside the rear leg member 110, which has a hollow-type construction to permit movement of the linkage 612 within the rear leg member 110 shown. The example linkage 612 shown in FIGS. 6 and 9 can include a handle arm 614, a front leg arm 616, and a slider component or rear leg arm 618. In other embodiments, a linkage 612 may have fewer or a greater number of a component and may have a different configuration than shown.

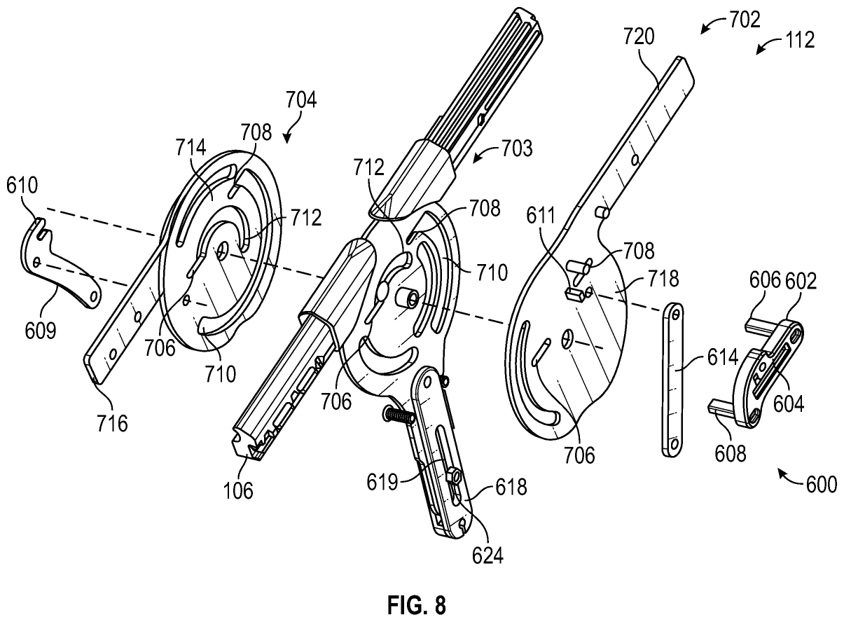

The handle arm 614, which can be an elongated arm shape, is operable to connect at one end to, as shown in FIG. 7, the handle hub plate 704, and which can transfer a force to or from the handle hub plate 704 to cause the one or more handle members 106 to rotate towards or away from a respective rear leg member 110. An opposing end of the handle arm 614 can mount to or otherwise connect with the slider component or rear leg arm 618. The handle hub plate 704, as shown in FIGS. 7 and 8, can include a circular portion 714 and an extended arm 716. The circular portion 714 can be sized to fit within the hub mechanism 112, and the extended arm 716 can extend from the circular portion 714, and outward from the hub mechanism 112, to mount or otherwise connect to the one or more handle members 106.

The front leg arm 616, which as shown in FIG. 6 can be an elongated arm shape, is operable to connect at one end to, as shown in FIG. 7, a front leg hub plate 702, and which can transfer a force to or from the front leg hub plate 702 to cause the one or more front leg members 108 to rotate towards or away from a respective rear leg member 110. An opposing end of the front leg arm 616 can mount to or otherwise connect with the slider component or rear leg arm 618. The front leg hub plate 702, as shown in FIGS. 7 and 8, can include a circular portion 718 and an extended arm 720. The circular portion 718 can be sized to fit within the hub mechanism 112, and the extended arm 720 can extend from the circular portion 718, and outward from the hub mechanism 112, to mount or otherwise connect to the one or more front leg members 108.

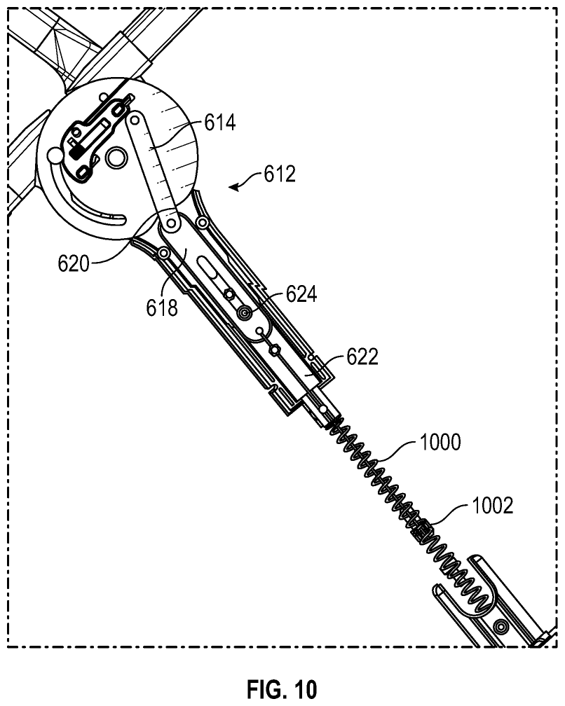

The slider component or rear leg arm 618, which as shown in FIGS. 6, 8, 9, and 10 can be an elongated arm shape with a central slot 619, is operable to connect to the front leg arm 616 and handle arm 614 at, for example, a pivot point 620. As shown in FIG. 6, the slider component or rear leg arm 618 can transfer a force respectively to or from one or more rear leg cables 622, a cable connection member 624, and, as shown in FIG. 10, at least one spring 1000 and terminal point 1002, to cause the linkage 612 to move downward or upward within a respective rear leg member 110. The slider component or rear leg arm 618 can include a slot 626 operable to permit the cable connection member 624 to slide with respect to the slider component or rear leg arm 618.

Within the rear leg member 110 shown in FIG. 10, the spring 1000 can connect between an opposing end of the slider component or rear leg arm 618 and the terminal point 1002, which is connected to or otherwise mounted to a lower portion of the rear leg member 110. The spring 1000 can cooperate with the rear leg cable 622 and slider component or rear leg arm 618, wherein, when the handle member 106 is being closed or otherwise folded towards the rear leg member 110, the spring 1000 can be compressed against the terminal point 1002. Likewise, when the handle member 106 is being opened or otherwise unfolded or moved away from the rear leg member 110, a compression force in the spring 1000 can be released to push the rear leg arm 618 away from the terminal point 1002 and transferring a portion of the force to the hub mechanism 112. Thus, when the lock 600 in the hub mechanism 112 is released, the front leg arm 616 and handle arm 614 can begin to respectively rotate the front leg hub plate 702 and handle hub plate 704 towards the one or more rear leg members 110, thus causing the slider component or rear leg arm 618 to provide a compression force to the at least one spring 1000 in the respective rear leg member 110. The one or more rear leg cables 622 extending from an opposing end of the slider component or rear leg arm 618 to a lower portion of the rear leg member 110, in some instances, to the terminal point 1002, can help to guide the slider component or rear leg arm 618 along a portion of the length and within the rear leg member 110.

In another embodiment, a linkage can extend from the hub mechanism 112 to the rear leg member 110, and movement of the linkage can be initiated in another manner than described herein. Other linkages and corresponding operations can be used with a stroller 100, and one skilled in the art will recognize how to implement these other linkages and corresponding operations with various embodiments according to the disclosure.

FIGS. 11A-11F present multiple views of the example stroller frame 102 for the compact automatic folding stroller 100 shown in FIG. 1 configured to fold from a use configuration to a folded configuration using the hub mechanism shown in FIGS. 6-10, according to an example embodiment of the disclosure. In FIG. 11A, the stroller frame 102 is shown in an open or use configuration 1100. When a user initiates a release mechanism 126, such as a first release and a second release, for instance, pressing a thumb switch and manipulating a pull switch on the one or more handle members 106, the distal end portion 122 of the upper portion 120 of the one or more handle members 106 can fold, in the direction of arrow 1102, towards a lower portion 124 of the one or more handle members 106 as shown in FIG. 11B. In conjunction or simultaneously with the distal end 122 of the upper portion 120 of the one or more handle members 106 folding towards a lower portion 124 of the one or more handle members 106, as shown in FIG. 11C, the hub mechanism 112 can coordinate movement of the one or more front leg members 108 towards, in the direction of arrow 1104, the one or more rear leg members 110, while the one or more folded handle members 106 begin to fold towards, in the direction of arrow 1106, the one or more rear leg members 110. As shown in FIGS. 11D and 11E, the hub mechanism 112 continues to coordinate movement or folding of the one or more front leg members 108 and the one or more folded handle members 106 towards the one or more rear wheel leg members 110. As shown in FIG. 11F, the stroller frame 102 can be positioned in a closed or folded configuration 1108 for storage, travel, or loading into a relatively compact space, such as an overhead bin of an airplane or a storage compartment of a car or automobile. The crossbar 126 can be used to carry or otherwise transport the folded or closed stroller frame 102.

To unfold or open the stroller frame 102 from the closed or folded configuration 1108, a user can grasp one or more of the handle members 106 and pull the one or more handle members 106 outward or away from the one or more rear leg members 110, which can cause the hub mechanism 112 to cause the one or more front leg members 108 to move away from the one or more rear leg members 110. When the stroller frame 102 reaches the configuration shown in FIG. 11B, the upper portion 120 of the one or more handle members 106 can be extended away from the lower portion 124 of the one or more handle members 106 until the stroller frame reaches the open or use configuration shown in FIG. 11A.

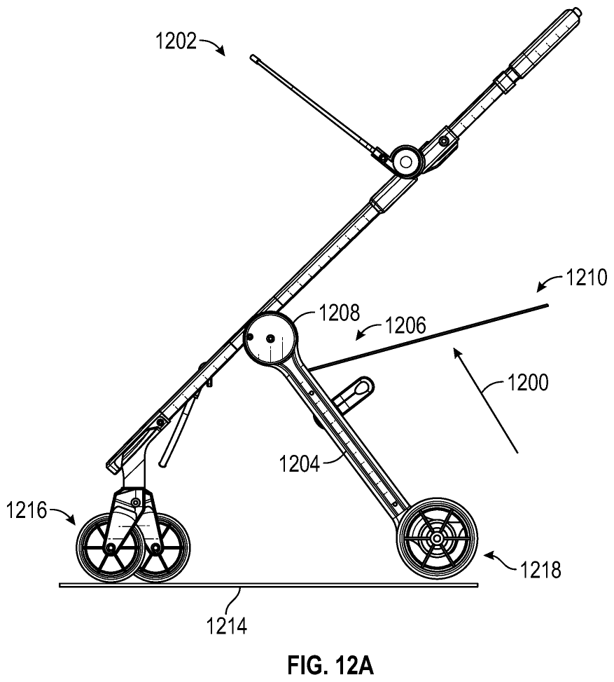

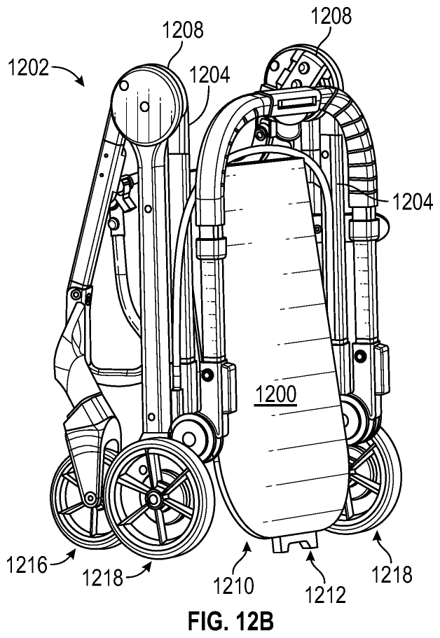

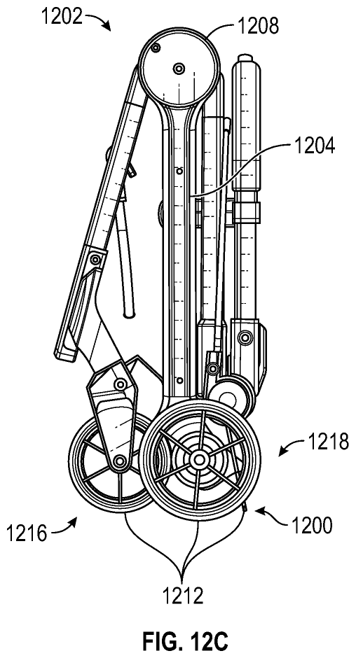

FIGS. 12A-12C illustrate an example backrest configuration for the example stroller of FIG. 1 and stroller frame of FIG. 2, according to an example embodiment of the disclosure. In FIG. 12A, a side view of a backrest 1200 for a stroller frame 1202, in an unfolded or open configuration, similar to the stroller frame 102 in FIG. 2, is shown. In this embodiment, the backrest 1200 can be connected to one or more rear leg members 1204, wherein an inner end 1206 of the backrest 1200 can connect to the one or more rear leg members 1204 adjacent to the hub mechanism 1208. The backrest 1200, for example, can be a relatively thin sheet of polyethylene or similar flexible and rigid material that can coordinate with softgoods to provide a relatively comfortable back support for a child seated in the stroller. In certain embodiments, any number of additional components, such as one or more softgoods, webbing, crossbars, connecting members, and/or mounting framers or brackets, can be used to connect the backrest 1200 to the one or more rear leg members 1204 adjacent to the hub mechanism 1208.

As shown in FIG. 12B, when the stroller frame 1202 is in a folded or closed configuration, the backrest 1200 can fold from a deployed orientation shown in FIG. 12A to a folded configuration. The backrest 1200, in the folded configuration, can pivot with respect to the one or more rear leg members 1204 to a relatively parallel orientation with the one or more rear leg members 1204, shown in this view, between a pair of rear leg members 1204. An outer end 1210 of the backrest 1200 appears to have a U-shaped tip 1212 that permits the folded stroller frame 1202 to maintain a relatively upright orientation with at least three points of contact with a supporting surface, such as the ground 1214. The U-shaped tip can have, for example, two feet or corners configured to touch and/or grip the supporting surface or ground, and avoid the backrest 1200 or associated softgoods from contacting the surface or ground. In the example shown in FIG. 12C, the three points of contact with the ground 1214 can be the front pair of wheels 1216, the rear pair of wheels 1218, and the U-shaped tip 1212 of the backrest 1200. Any number of adjacent components of the stroller frame 1202 including handle members, front or rear leg members, for example, can be adjusted in length to provide the three points of contact with the surface or ground 1214. In this manner, the three points of contact can maintain the folded stroller frame 1202 in the relatively upright orientation with respect to a supporting surface, such as the ground 1214.

The above-described stroller 100, stroller frames 102, 1202, and embodiments shown in the Figures can provide an easy, optionally one-handed method for automatically folding the stroller 100 and stroller frame 102, 1202. During the entire process of folding the stroller 100 and stroller frame 102, 1202 from the open or use configuration 1100 to the closed or folded configuration 1102, the user can use her or his other hand to hold the child, a diaper bag, other contents that were in the stroller and/or any other goods that the user desires.

While the example embodiments discussed above present a particular stroller frame 102, 1202 and associated layout or configuration for the stroller 100, these are for example purposes only as the stroller can have any other type of frame layout or configuration known to those or ordinary skill in the art. Further, while the example embodiments above show a particular type of hub mechanism 112 and an example way for various components of the stroller frame 102, 1202 to operably connect to the hub mechanism 112, this is also only for example, as strollers can have many forms of a hub mechanism and its coordination of the folding movements of various components of the stroller frame can be adjusted as needed to accommodate fewer or greater numbers of components of other stroller frames.

While the above description contains many specifics, these specifics should not be construed as limitations on the scope of the disclosure, but merely as exemplifications of the disclosed embodiments. Those skilled in the art will envision many other possible variations that are within the scope of the disclosure.

Additionally, although example embodiments have been described in language specific to structural features and/or methodological acts, it is to be understood that the disclosure is not necessarily limited to the specific features or acts described. Rather, the specific features and acts are disclosed as illustrative forms of implementing the example embodiments. Conditional language, such as, among others, “can,” “could,” “might,” or “may,” unless specifically stated otherwise, or otherwise understood within the context as used, is generally intended to convey that certain example embodiments could include, while other example embodiments do not include, certain features, elements, operations, and/or steps. Thus, such conditional language is not generally intended to imply that features, elements, operations, and/or steps are in any way required for one or more embodiments.

What is claimed is:

1. A stroller comprising:
a stroller frame comprising a handle member, a front leg member, and a rear leg member; and
a hub mechanism, wherein the handle member, front leg member, and rear leg member are coupled to one another via the hub mechanism, the hub mechanism comprising:
a handle arm operable to connect to a lower portion of the handle member;
a front leg arm operable to connect to the front leg member; and
a rear leg arm operable to connect to the rear leg member; and
a linkage operable to coordinate movements of the handle arm, front leg arm, and rear leg arm;
wherein when an upper portion of the handle member is manipulated towards the lower portion of the handle member, the hub mechanism releases the linkage, causing the linkage to:
rotate the front leg arm to fold the front leg member towards the rear leg member;
rotate the handle arm to fold the lower portion of the handle member towards the rear leg member;
wherein the front leg member, upper portion of the handle member, and lower portion of the handle member can be maintained in a folded configuration with respect to the rear leg member.

2. The stroller of claim 1, wherein the handle member comprises:
a release mechanism configured to initiate folding of the upper portion of the handle member towards the lower portion of the handle member, wherein an initial length of the handle member is shortened to a folded length of the handle member; and
at least one pivot device in communication with the first release, wherein the at least one pivot device facilitates folding the upper portion of the handle member towards the lower portion of the handle member.

3. The stroller of claim 2, further comprising:
at least one handle member cable connected to the hub mechanism, wherein when the release mechanism initiates folding of the handle member, the at least one handle member cable causes a locking device in the hub mechanism to release the linkage.

4. The stroller of claim 1, wherein the linkage connects to:
a slider component within the rear leg member;
the handle arm; and
the front leg arm,
wherein the rear leg member connects to at least one rear leg member cable and a spring.

5. The stroller of claim 4, wherein when the linkage is released, the slider component moves with respect to the rear leg member to compress the spring, wherein the front leg arm pulls the front leg member towards the rear leg member simultaneously with the handle plate pulling the handle member towards the rear leg member.

6. The stroller of claim 1, wherein the handle arm connects to the handle member via at least one handle member cable, and the front leg arm connects to the front leg member via at least one front leg member cable.

7. The stroller of claim 2, wherein the release mechanism comprises a first release and a second release, wherein the first release comprises a thumb button or switch, and the second release comprises a squeeze button.

8. The stroller of claim 2, wherein initiation of the release mechanism causes the at least one pivot mechanism to unlock.

9. The stroller of claim 1, further comprising:
a backrest mounted to the stroller frame, wherein when the stroller is in the folded configuration, the backrest provides an additional contact point with a ground surface.

10. A method of folding a stroller from a use configuration to a folded configuration comprising:
providing a stroller configured to be adjusted from the use configuration to the folded configuration, the stroller comprising:
a stroller frame comprising a handle member, a front leg member, and a rear leg member; and
a hub mechanism, wherein the handle member, front leg member, and rear leg member are coupled to one another via the hub mechanism, the hub mechanism comprising:
a handle arm operable to connect to a lower portion of the handle member;
a front leg arm operable to connect to the front leg member;
a rear leg arm operable to connect to the rear leg member; and
a linkage; and
manually releasing, by a first hand of a user, an upper portion of the handle member to begin folding towards the front leg member;
wherein folding the upper portion of the handle member towards the front leg member causes the hub mechanism to rotate the front leg arm to fold the front leg member towards the rear leg member, and further causes the hub mechanism to rotate the handle arm to fold the lower portion of the handle member towards the rear leg member; and
wherein the front leg member, upper portion of the handle member, and lower portion of the handle member can be maintained in a folded configuration with respect to the rear leg member.

11. The method of claim 10, wherein the handle member comprises:
a release mechanism configured to initiate folding of the upper portion of the handle member towards the lower portion of the handle member, wherein an initial length of the handle member is shortened to a folded length of the handle member; and
at least one pivot device in communication with the first release, wherein the at least one pivot device facilitates folding the upper portion of the handle member towards the lower portion of the handle member.

12. The method of claim 11, further comprising:
at least one handle member cable connected to the hub mechanism, wherein when the release mechanism initiates folding of the handle member, the at least one handle member cable causes a locking device in the hub mechanism to release the linkage.

13. The method of claim 10, wherein the linkage connects to:
a slider component within the rear leg member;
the handle arm; and
the front leg arm,
wherein the rear leg member connects to at least one rear leg member cable and a spring.

14. The method of claim 10, wherein when the linkage is released, the slider component moves with respect to the rear leg member to compress the spring, wherein the front leg arm pulls the front leg member towards the rear leg member simultaneously with the handle plate pulling the handle member towards the rear leg member.

15. The method of claim 10, wherein the handle plate connects to the handle member via at least one handle member cable, and the front leg arm connects to the front leg member via at least one front leg member cable.

16. The method of claim 11, wherein the release mechanism comprises a first release and a second release, wherein the first release comprises a thumb button or switch, and the second release comprises a squeeze button.

17. The method of claim 11, wherein initiation of the release mechanism causes the at least one pivot mechanism to unlock.

18. A hub mechanism for a stroller, wherein a handle member, a front leg member, and a rear leg member are coupled to one another via the hub mechanism, the hub mechanism comprising:
a handle arm operable to connect to a lower portion of the handle member;
a front leg arm operable to connect to the front leg member; and
a rear leg arm operable to connect to the rear leg member; and
wherein when an upper portion of the handle member is manipulated towards the lower portion of the handle member, the hub mechanism releases a linkage, causing the linkage to:
rotate the front leg arm to fold the front leg member towards the rear leg member;
rotate the handle arm to fold the lower portion of the handle member towards the rear leg member;
wherein the front leg member, upper portion of the handle member, and lower portion of the handle member can be maintained in a folded configuration with respect to the rear leg member.

19. The hub mechanism of claim 18, wherein at least one handle member cable connects to the hub mechanism, wherein when a release mechanism initiates folding of the handle member, the at least one handle member cable causes a locking device in the hub mechanism to release the linkage.

20. The hub mechanism of claim 18, wherein the linkage connects to:
a slider component within the rear leg member;
the handle arm; and
the front leg arm,
wherein the rear leg member connects to at least one rear leg member cable and a spring;
wherein when the linkage is released, the slider component moves with respect to the rear leg member to compress the spring, wherein the front leg arm pulls the front leg member towards the rear leg member simultaneously with the handle arm pulling the handle member towards the rear leg member.
